(19) United States
(12) Patent Application Publication
(10) Pub. No.: US 2008/0220218 A1
(43) Pub. Date: Sep. 11, 2008

(54) Ornamental soft solid magnet and a manufacturing method thereof

(76) Inventors: Tzu-Ying Wu, Taipei City (TW); Hung-Yu Chen, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/714,549

(22) Filed: Mar. 6, 2007

(51) Int. Cl. B32B 1/00; D04H 1/20

(52) U.S. Cl. 428/187; 264/112

(57) ABSTRACT

An ornamental soft solid magnet and a manufacturing method thereof. The soft solid magnet includes at least one magnetic substrate made of magnetic material and a facial layer with figures or characters. The facial layer is combined with the substrate to form an integrated sheet body. The sheet body is mold-pressed by a mold set to form the ornamental soft solid magnet. The mold set includes an upper mold section and a lower mold section made of soft material. The upper mold section is preformed with recessed/embossed figures or characters in accordance with the figures or characters of the facial layer. After pressed, the sheet body is placed on a magnetically attractive surface, whereby after the sheet body is cooled and patterned, the sheet body keeps in a plane state without shrinking, curving or deforming.

### BACKGROUND OF THE INVENTION

The present invention is related to an improved soft solid magnet, and more particularly to an ornamental soft solid magnet has finer solid figures or characters. The solid magnet is made at lower cost.

A flat plate with at least one magnetic face can attract an iron-made object or board for fixing papers or thin sheets on the board for easy taking or watching. Generally, ferric oxide powder is added into a complex material which is a mixture of rubber and plastic. The material is at least once magnetized. Pulse current passes through a magnetic conductive disc with different magnetized divisions to induce different magnetic poles on the surface of the substrate material. Accordingly, a flexible magnetic product is formed. Such products can attract each other or attract an iron-made object (attracted object).

In general, such magnetic product is combined with a facial layer printed with figures or characters. Conventionally, the facial layer printed with the plane figures is attached to the surface of the soft magnet. With respect to surface printing, by means of printing color-separating technique, the color can be mobilely changed. However, such product lacks solid feeling. In order to achieve a solid feeling on the facial layer of the soft magnet, the conventional injection molding technique is used to form embossed figures on the surface of soft magnet. Then, the embossed figures are laboriously colored as necessary. Such measure leads to monotonous colors of the figures. In addition, it is impossible to mass-produce the soft magnets by a machine. Therefore, the manufacturing cost is relatively high.

This applicant's Taiwanese Patent Application No. 81109982 discloses a method for manufacturing soft magnetic sheet with facial solid figures and a product thereof. The facial layer is first printed with a figure. Then, by means of a high-frequency mold press and a punch procedure, the facial layer, a foam middle layer, a magnet and a bottom layer are combined to achieve a decorative magnet product with a surface with a solid colorful figure.

However, the above decorative magnet product with the PVC/foam middle layer sandwiched between the facial layer and the magnetic layer fails to meet the requirement for environmental protection. There is another quite complicated vacuumizing measure for forming embossed PVC facial structure. Multiple vacuum sucking vents are densely arranged in a mold cavity according to a necessary figure. In operation, the PVC facial layer material is laid in the mold cavity of the lower mold section and heated and softened. At this time, by means of vacuum sucking, the material is recessed in accordance with the recessed/embossed portions of the lower mold section. After cooled and molded, the material is demolded without shrinking or curving. Such conventional mold set has complicated structure so that the manufacturing cost is relatively high. In addition, the solid figure is formed in the mold by means of vacuum sucking so that the figure is only a profile of the recessed/embossed structure of the mold. Accordingly, the figure can be hardly finely formed as in mold press operation.

Therefore, it is tried by the applicant to provide a novel magnetic product with newly designed texture and a manufacturing method thereof. The usage of the magnetic product can is variable and different from the prior art. Also, the application range of the magnetic product is widened. For example, in condition of environmental protection, the magnetic product can be made with the mold cost saved. Moreover, finer solid figures or characters can be made and integrated with the magnetic layer.

### SUMMARY OF THE INVENTION

It is therefore a primary object of the present invention to provide an ornamental soft solid magnet and a manufacturing method thereof. The solid magnet has finer ornamental figures. Also, the solid magnet is made to meet the requirements for environmental protection. In addition, the cost for the mold is reduced. The soft solid magnet includes at least one magnetic substrate made of magnetic material and a facial layer with figures or characters. The facial layer is combined with the substrate to form an integrated sheet body. The sheet body is mold-pressed by a mold set to form the ornamental soft solid magnet with recessed/embossed figures or characters corresponding to the figures or characters of the facial layer. The mold set includes an upper mold section and a lower mold section made of soft material. The upper mold section is preformed with recessed/embossed figures or characters in accordance with the figures or characters of the facial layer.

It is a further object of the present invention to provide the above ornamental soft solid magnet and the manufacturing method thereof. The substrate has a first face and a second face. The facial layer is attached to the first face of the substrate. A magnetic layer is further laid on the second face of the substrate. After going through a mold press operation, the facial layer, the substrate and the magnetic layer are combined into an integrated ornamental solid magnet.

It is still a further object of the present invention to provide the above ornamental soft solid magnet and the manufacturing method thereof. The method for manufacturing the ornamental soft solid magnet includes steps of:
(a) laying a facial layer with figures or characters on a substrate to form a sheet body;
(b) making the sheet body go through a mold press operation of a mold set to accurately form recessed/embossed solid structure corresponding to the figures or characters of the facial layer; and
(c) placing the sheet body with the recessed/embossed structure on a magnetically attractive surface, by means of the attraction between the magnetically attractive surface and the sheet body, during the cooling procedure, the sheet body being rectified and prevented from shrinking, curving or deforming.

It is still a further object of the present invention to provide the above ornamental soft solid magnet and the manufacturing method thereof. The method for manufacturing the ornamental soft solid magnet further includes a step of (d) combining the sheet body and a magnetic layer into an integrated body. The magnetic layer has at least one plane polished face, whereby after the sheet body is combined with the magnetic layer, the product has a plane polished back face.

The present invention can be best understood through the following description and accompanying drawings wherein:

### BRIEF DESCRIPTION OF THE DRAWINGS

FIG. 1 is a sectional view of the sheet body and the mold set of the present invention;

FIG. 2 is a sectional view according to FIG. 1, showing that the sheet body is pressed by the mold set;

FIG. 3 is a sectional view according to FIG. 2, showing that the sheet body is recessed/embossed after pressed by the mold set;

FIG. 4 is a sectional view showing that the sheet body is rested on a magnetically attractive surface or nonmagnetic surfaces;

FIG. 5 is a perspective exploded view of the sheet body and the magnetic layer of the present invention;

FIG. 6 is a perspective view showing that the sheet body and the magnetic layer are integrated; and

FIG. 7 is a sectional view according to FIG. 6.

### DETAILED DESCRIPTION OF THE PREFERRED EMBODIMENTS

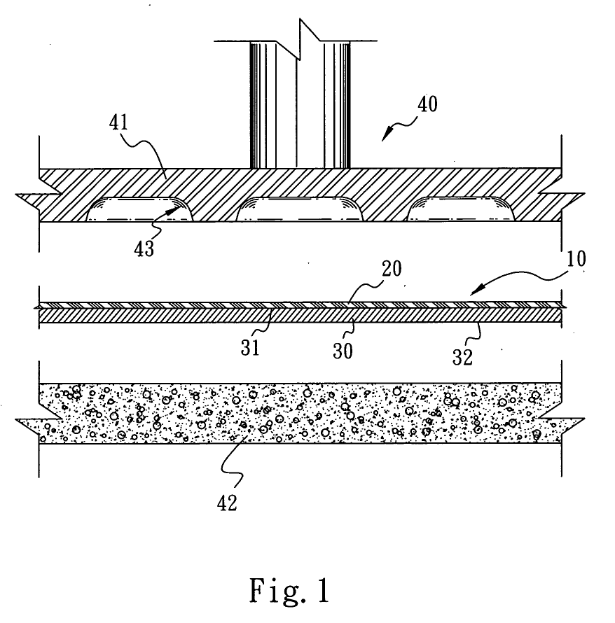

Please refer to FIG. 1. The ornamental soft solid magnet of the present invention has a sheet body 10 including a facial layer 20 and a substrate 30. The facial layer 20 is printed with figures or characters and attached or adhered to the substrate 30 to form an integrated sheet body 10. In a preferred embodiment, the substrate 30 is a magnetic body having a first face 31 and a second face 32. The facial layer 20 is attached to the first face 31 of the substrate 30.

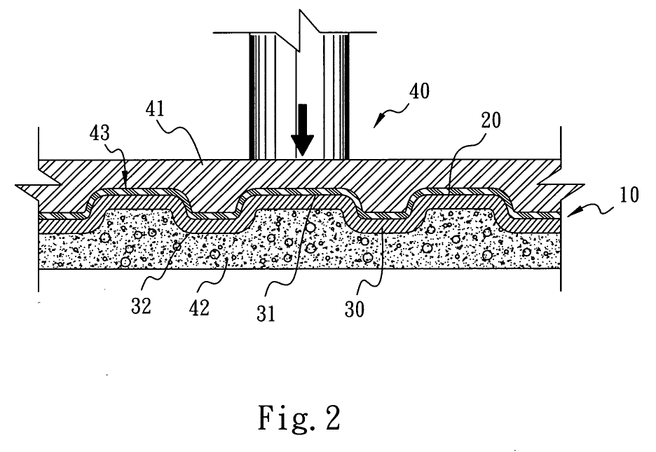

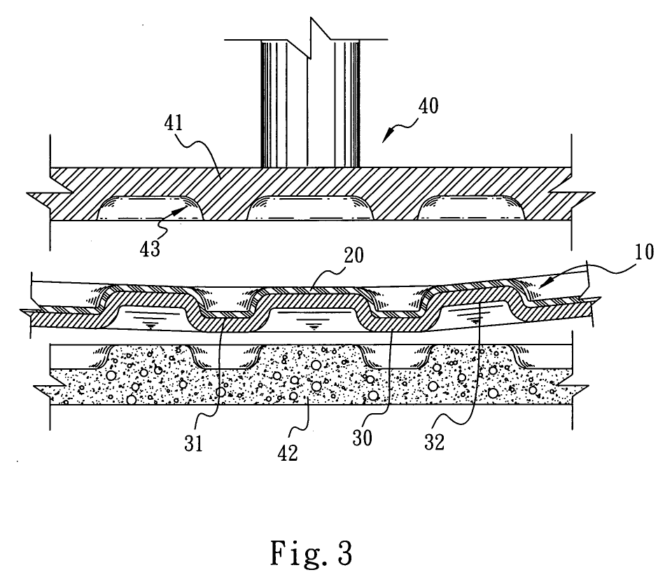

Referring to FIGS. 2 and 3, by means of high-frequency or ultrasonic mold press operation, the sheet body 10 can be accurately formed with recessed/embossed solid structure corresponding to the printed figures or characters. In this embodiment, the mold set 40 includes an upper mold section 41 and a lower mold section 42 made of soft material. The interior of the upper mold section 41 is formed with recessed/embossed figures 43 in accordance with the figures or characters of the facial layer 20. The lower mold section 42 can be made of foam material or the like with certain flexibility, for example, sponge rubber. The lower mold section 42 cooperates with the upper mold section 41 to together press the sheet body 10. The lower mold section 42 also serves as a rest or buffer section for the upper mold section 41. Referring to FIGS. 2 and 3, when the upper mold section 41 presses down the sheet body 10 and the lower mold section 42, the high-frequency or ultrasonic technique is co-used to forcedly form recessed/embossed structures on the sheet body 10 and the lower mold section 42 as the figures or characters printed on the facial layer 20.

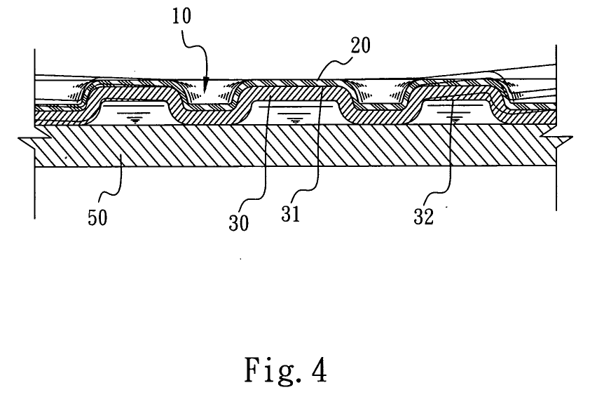

Referring to FIG. 4, after molded by the mold set 40, the not yet cooled and stabilized sheet body 10 is immediately rested on a magnetically attractive surface 50. By means of the attraction between the magnetically attractive surface 50 and the sheet body 10, the magnetically attractive surface 50 can guide and rectify the sheet body 10. Therefore, during the cooling procedure, the sheet body 10 is prevented from shrinking. Accordingly, a plane magnetic product can be formed. To speak in detail, the substrate 30 is made of magnetic material. Therefore, the magnetically attractive surface 50 and the sheet body 10 can attract each other. Accordingly, during the cooling procedure, the sheet body 10 is prevented from shrinking, curving or deforming. The sheet body 10 will not be taken off from the magnetically attractive surface 50 until the sheet body 10 is cooled and patterned. Therefore, the sheet body 10 will keep in a plane state to achieve a plane ornamental soft solid magnet.

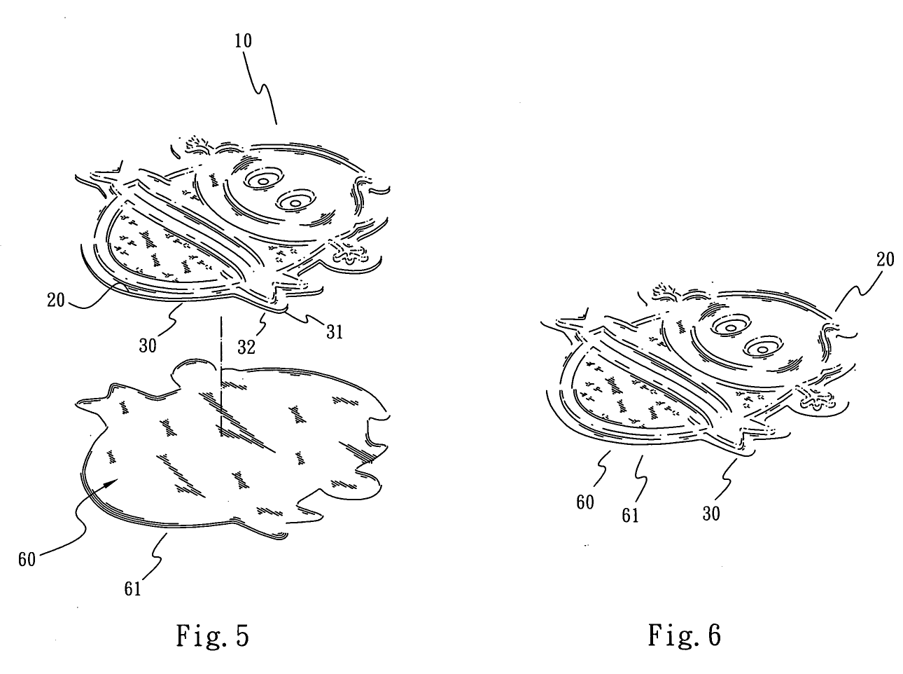

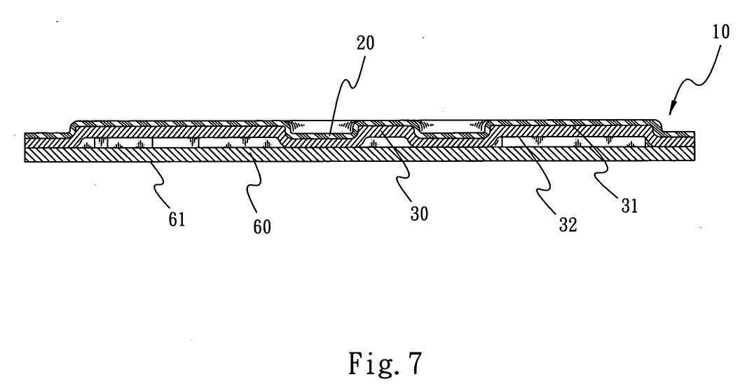

Referring to FIGS. 5 and 6, in a preferred embodiment, the facial layer 20 with the figures or characters is bonded with the first face 31 of the substrate 30. In addition, a magnetic layer 60 can be further laid on the second face 32 of the substrate 30. The magnetic layer 60 not only serves to enhance the magnetism of the sheet body 10, but also serves to cover the recessed/embossed outer surface of the substrate 30, which is formed by the mold set 40. After going through a mold press operation, the facial layer 20, the substrate 30 and the magnetic layer 60 are combined into an ornamental solid magnet with a plane back face and a front face having solid figures or characters as shown in FIG. 7. In this embodiment, the magnetic layer 60 at least has a polished face 61, whereby after the sheet body 10 is combined with the magnetic layer 60, the product has a plane polished surface.

The method for manufacturing the ornamental soft solid magnet of the present invention includes steps of:
(a) laying a facial layer 20 with figures or characters on a substrate 30 to form a sheet body 10;
(b) making the sheet body 10 go through a high-frequency or ultrasonic mold press operation of a mold set 40 to accurately form recessed/embossed solid structure corresponding to the figures or characters of the facial layer 20;
(c) placing the sheet body 10 with the recessed/embossed structure on a magnetically attractive surface 50, by means of the attraction between the magnetically attractive surface 50 and the sheet body 10, during the cooling procedure, the sheet body 10 being prevented from shrinking, curving or deforming (as shown by the phantom line of FIG. 4), the sheet body 10 being not taken off from the magnetically attractive surface 50 until the sheet body 10 is cooled and patterned, whereby the sheet body keeps in a plane state as shown by solid line of FIG. 4; and
(d) combining the sheet body 10 and a magnetic layer 60 into an integrated body, the magnetic layer 60 having at least one plane polished face 61, whereby after the sheet body 10 is combined with the magnetic layer 60, the product has a plane polished back face.

It should be noted that in the case the substrate 30 is made of a magnetic material such as a magnet, after the substrate 30 and the facial layer 20 are combined, basically, an ornamental solid magnet with recessed/embossed front face and back face is achieved. In case it is required to reduce the cost, step (d) is omissible.

According to the above arrangement, the solid magnet has finer ornamental figures. Also, the solid magnet is made to meet the requirements for environmental protection. In addition, the cost for the mold is reduced.

The above embodiments are only used to illustrate the present invention, not intended to limit the scope thereof. Many modifications of the above embodiments can be made without departing from the spirit of the present invention.

What is claimed is:

1. An ornamental soft solid magnet comprising:
at least one magnetic substrate having a first face and a second face; and
a facial layer with figures or characters, the facial layer being combined with the substrate to form an integrated sheet body, the sheet body being mold-pressed by a mold set to form the ornamental soft magnet having a front face and a back face, the front face and the back face both having recessed/embossed figures or characters corresponding to the figures or characters of the facial layer.

2. The ornamental soft solid magnet as claimed in claim 1, wherein the mold set includes an upper mold section and a lower mold section made of soft material, the upper mold section being preformed with recessed/embossed figures or characters in accordance with the figures or characters of the facial layer.

3. The ornamental soft solid magnet as claimed in claim 2, wherein the lower mold section is made of foam material or the like.

4. The ornamental soft solid magnet as claimed in claim 1, wherein a magnetic layer is laid on the second face of the substrate.

5. The ornamental soft solid magnet as claimed in claim 2, wherein a magnetic layer is laid on the second face of the substrate.

6. The ornamental soft solid magnet as claimed in claim 3, wherein a magnetic layer is laid on the second face of the substrate.

7. The ornamental soft solid magnet as claimed in claim 4, wherein one face of the magnetic layer distal from the sheet body is a plane face.

8. The ornamental soft solid magnet as claimed in claim 5, wherein one face of the magnetic layer distal from the sheet body is a plane face.

9. The ornamental soft solid magnet as claimed in claim 6, wherein one face of the magnetic layer distal from the sheet body is a plane face.

10. A method for manufacturing an ornamental soft solid magnet, comprising steps of:
(a) laying a facial layer with figures or characters on a magnetic substrate to form a sheet body;
(b) making the sheet body go through a mold press operation of a mold set, an interior of the mold set being formed with recessed/embossed surface, whereby after pressed, a recessed/embossed solid structure is formed on the surface of the sheet body corresponding to the recessed/embossed surface of the mold set;
(c) placing the sheet body with the recessed/embossed structure on a magnetically attractive surface, whereby after the sheet body is cooled and patterned, the sheet body keeps in a plane state without shrinking, curving or deforming.

11. The method for manufacturing the ornamental soft solid magnet as claimed in claim 10, after step (c), further comprising a step of (d) combining the sheet body and a magnetic layer into an integrated body.

12. The method for manufacturing the ornamental soft solid magnet as claimed in claim 10, wherein the mold set includes an upper mold section and a lower mold section made of soft material, an interior of the upper mold section being formed with recessed/embossed figures or characters in accordance with the figures or characters of the facial layer.

13. The method for manufacturing the ornamental soft solid magnet as claimed in claim 11, wherein the mold set includes an upper mold section and a lower mold section made of soft material, an interior of the upper mold section being formed with recessed/embossed figures or characters in accordance with the figures or characters of the facial layer.

14. The method for manufacturing the ornamental soft solid magnet as claimed in claim 12, wherein the soft material is a foam material or the like.

15. The method for manufacturing the ornamental soft solid magnet as claimed in claim 13, wherein the soft material is a foam material or the like.

16. The method for manufacturing the ornamental soft solid magnet as claimed in claim 12, wherein when the upper mold section presses down the sheet body and the lower mold section, recessed/embossed figures or characters are directly formed on the surface of the sheet body and the lower mold section corresponding to the figures or characters of the facial layer.

17. The method for manufacturing the ornamental soft solid magnet as claimed in claim 13, wherein when the upper mold section presses down the sheet body and the lower mold section, recessed/embossed figures or characters are directly formed on the surface of the sheet body and the lower mold section corresponding to the figures or characters of the facial layer.

18. The method for manufacturing the ornamental soft solid magnet as claimed in claim 14, wherein when the upper mold section presses down the sheet body and the lower mold section, recessed/embossed figures or characters are directly formed on the surface of the sheet body and the lower mold section corresponding to the figures or characters of the facial layer.

19. The method for manufacturing the ornamental soft solid magnet as claimed in claim 15, wherein when the upper mold section presses down the sheet body and the lower mold section, recessed/embossed figures or characters are directly formed on the surface of the sheet body and the lower mold section corresponding to the figures or characters of the facial layer.
